(19) United States
(12) Patent Application Publication
(10) Pub. No.: US 2025/0245993 A1
(43) Pub. Date: Jul. 31, 2025

(54) SYSTEM AND METHOD OF USING AERIAL DATA FOR DETECTING FRACKING ACTIVITY

(71) Applicant: Enverus, Inc., Austin, TX (US)

(72) Inventors: Sam Dawson, Austin, TX (US); Eric Troilo, North Wildwood, NJ (US); Claire McKenzie, Austin, TX (US); Curtis Hess, Calgary (CA); Jiarao Huang, Calgary (CA); Jingwen Zheng, Calgary (CA); Livan Alonso, Bryn Mawr, PA (US)

(73) Assignee: Enverus, Inc., Austin, TX (US)

(21) Appl. No.: 19/036,672

(22) Filed: Jan. 24, 2025

Related U.S. Application Data
(60) Provisional application No. 63/627,537, filed on Jan. 31, 2024.

(51) Int. Cl. G06V 20/52; G06V 10/764; G06V 20/60

(52) U.S. Cl. CPC G06V 20/52; G06V 10/764; G06V 20/60

(57) ABSTRACT

A method for monitoring fracturing activities is disclosed herein. A computing system receives aerial images of a geographical region. The computing system analyzes the aerial images to detect a presence of a well pad within the geographical region. The computing system receives further aerial images of the well pad. The computing system monitors the further aerial images to identify fracking activity on the well pad. The computing system records the fracking activity.

### FIELD OF DISCLOSURE

The present disclosure generally relates to a system and method of detecting well pad and/or fracking activity on the well pad based on aerial images.

### BACKGROUND

In the oil and gas industry, the process of hydraulic fracturing, commonly known as “fracking”, is a widely used technique for extracting natural gas and oil from deep underground. This process involves the injection of water, sand, and chemicals into a wellbore to create fractures in the deep-rock formations, thereby allowing natural gas or oil to flow more freely.

Monitoring the activities of fracking crews is a complex task that requires accurate and timely data. Traditionally, this information has been obtained through manual reporting by the crews themselves or through regulatory filings. However, these methods can often result in data that is delayed, inconsistent, or incomplete.

With the advent of satellite technology, it has become possible to monitor fracking activities from space. Satellites can capture images of the Earth's surface, which can then be analyzed to detect changes in the landscape that may indicate the presence of a fracking crew. For instance, the presence of increased metal onsite, which can be detected by radar imagery, may indicate the start or end of fracking activities.

However, interpreting these satellite images and correlating them with fracking activities is a complex task that requires sophisticated algorithms and machine learning techniques, such as convolutional neural networks and pattern recognition algorithms, among others. These algorithms and techniques are designed to analyze the satellite images, detect changes in the landscape, and predict the presence of a fracking crew based on these changes.

Furthermore, the integration of this satellite-derived data with other datasets, such as reported completion data, can provide a more comprehensive view of fracking activities. This integrated data can then be used to generate advanced analytics, which can provide valuable insights into the trends and patterns of fracking activities.

Despite these advancements, the process of detecting and monitoring fracking activities using satellite imagery and machine learning techniques is still a challenging task that requires continuous research and development.

### SUMMARY

In some embodiments, a method for monitoring hydraulic fracturing activities is disclosed herein. A computing system receives aerial images of a geographical region. The computing system analyzes the aerial images to detect a presence of a well pad within the geographical region. The computing system receives further aerial images of the well pad. The computing system monitors the further aerial images to identify fracking activity on the well pad. The computing system records the fracking activity.

In some embodiments, a non-transitory computer readable medium is disclosed herein. The non-transitory computer readable medium includes one or more sequences of instructions stored thereon, which, when executed by a processor, causes a computing system to perform operations. The operations include receiving, by a computing system, aerial images of a geographical region. The operations further include analyzing, by the computing system, the aerial images to detect a presence of a well pad within the geographical region. The operations further include receiving, by the computing system, further aerial images of the well pad. The operations further include monitoring, by the computing system, the further aerial images to identify fracking activity on the well pad. The operations further include recording, by the computing system, the fracking activity.

In some embodiments, a system is disclosed herein. The system includes a processor and a memory. The memory has programming instructions stored thereon, which, when executed by the processor, causes the system to perform operations. The operations include receiving aerial images of a geographical region. The operations further include analyzing the aerial images to detect a presence of a well pad within the geographical region. The operations further include receiving further aerial images of the well pad. The operations further include monitoring the further aerial images to identify fracking activity on the well pad. The operations further include recording the fracking activity.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating an exemplary computing environment, according to example embodiments.

FIG. 2 is a block diagram illustrating a computing system, according to example embodiments.

FIG. 3 is a block diagram illustrating a computing system, according to example embodiments.

FIG. 4 is a flow diagram illustrating a method of detecting a well pad, according to example embodiments.

FIG. 5 is a flow diagram illustrating a method of detecting fracking activity on a well pad, according to example embodiments.

FIG. 6 illustrates a plurality of radar images, according to example embodiment.

FIG. 7A is a block diagram illustrating a computing device, according to example embodiments of the present disclosure.

FIG. 7B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The traditional methods of monitoring hydraulic fracturing (fracking) activities have been fraught with challenges. Manual reporting by crews on the ground, while direct, is often subject to human error, delays in data entry, and inconsistencies due to varied reporting standards. Regulatory filings, on the other hand, provide official data but suffer from lag times in submission and may not capture real-time activities. These conventional approaches lack the immediacy and precision that are increasingly demanded in the fast-paced oil and gas industry. Furthermore, they do not provide the spatial resolution or the temporal frequency that is now achievable with modern technology. As a result, stakeholders in the industry have been seeking more reliable and efficient methods to gain insights into fracking operations.

Recent advancements in satellite technology have opened new avenues for monitoring fracking activities. The ability of satellites to capture high-resolution images (e.g., images as low as 30 cm per pixel) of the Earth's surface at regular intervals (e.g., daily or longer) has provided an unprecedented level of detail and timeliness in data collection. However, the sheer volume of data and the complexity of interpreting satellite imagery require sophisticated algorithms and machine learning techniques. The challenge lies in accurately detecting and correlating specific changes in the landscape, such as increased metal presence, to the activities of fracking crews. This task is further complicated by the dynamic nature of fracking sites, where equipment and infrastructure can change rapidly.

One or more techniques disclosed herein provide a comprehensive system that leverages the strengths of satellite imagery while addressing the limitations of traditional monitoring methods. By employing advanced machine learning algorithms and a robust analytics system, the present system provides a more accurate, timely, and detailed view of fracking activities. The system's ability to integrate satellite-derived data with other datasets, such as reported completion data and telemetric data, creates a multi-dimensional perspective of fracking operations. This integration not only enhances the accuracy of activity detection but also enriches the analytics with contextual insights that were previously unattainable. Moreover, the system's predictive capabilities, based on historical and real-time data, represent a substantial improvement over the reactive nature of manual reporting and regulatory filings. Overall, the present approach offers a transformative solution that elevates the monitoring of fracking activities to a new level of precision and efficiency. For example, through such approach, the present system may use any type of aerial imagery (e.g., infrared, optical, radar) to differentiate between fracking and other types of well activity.

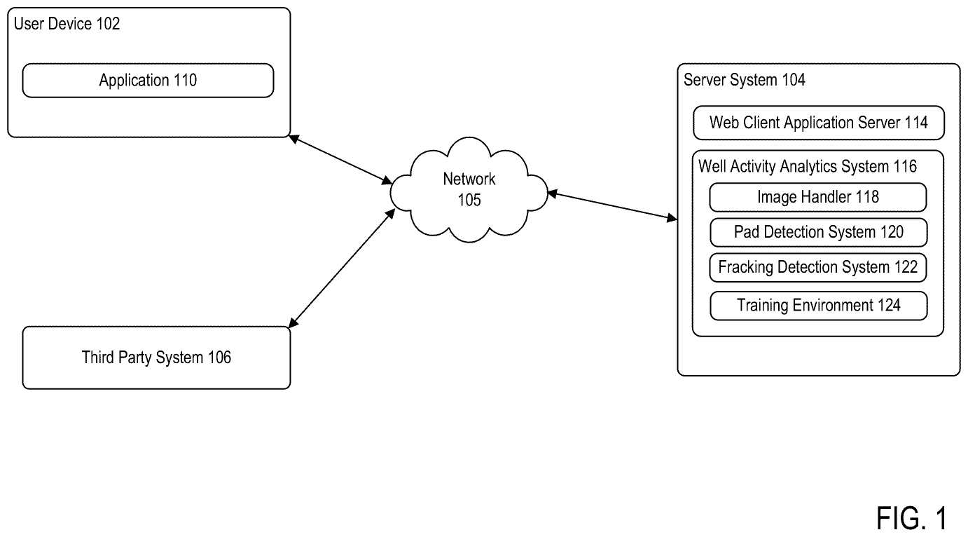

FIG. 1 is a block diagram illustrating a computing environment 100, according to example embodiments. As shown, computing environment 100 may include a use device 102, a server system 104, and a third-party system 106 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receive information between the components of computing environment 100.

User device 102 may be any type of computing device capable of receiving and sending data, such as a desktop computer, laptop, tablet, or smartphone. User device 102 may include application 110. Application 110 may allow a user to interact with server system 104. In some embodiments, application 110 may be a web-based application, a mobile application, or any other type of software application that enables a user to input data, view data, and perform various operations related to the identification of well activities in a geographic area or region.

Server system 104 may be configured to communicate with user device 102. Server system 104 may include web client application server 114 and well activity analytics system 116. Web client application server 114 may be configured to communicate with application 110 running on user device 102. Well activity analytics system 116 may be configured to detect various well activity events within a geographical region based on aerial images of the geographical region. In some embodiments, aerial images may be representative of satellite images. In some embodiments, aerial images may be representative of drone images. More generally, in some embodiments, aerial images may be representative of any remotely captured images of a geographical region. Well activity analytics system 116 may be comprised of one or more software modules. The one or more software modules may be collections of code or instructions stored on a media (e.g., memory of server system 104) that represent a series of machine instructions (e.g., program code) that implements one or more algorithmic steps. Such machine instructions may be the actual computer code the processor of server system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Well activity analytics system 116 may include an image handler 118, a pad detection system 120, a fracking detection system 122, and a training environment 124. Image handler 118 may be configured to receive and process data related to well activities, such as pad placement and drilling and fracking activities. In some embodiments, image handler 118 is configured to receive and process aerial images from the third-party system 106. The aerial images may be used by downstream systems (e.g., pad detection system 120 and fracking detection system 122) to detect pad and/or fracking activity within a geographical region. In some embodiments, the aerial images may be satellite images. For example, the aerial images may be satellite images captured by Sentinel 1 or Sentinel 2 Constellations. In some embodiments, image handler 118 may be configured to retrieve or receive aerial images from third-party system 106 for both training and deployment tasks.

Pad detection system 120 may be configured to detect the presence of well pads in the satellite images. For example, pad detection system 120 may be configured to analyze the satellite images and identify areas within the satellite images that have characteristics of a well pad. In some embodiments, pad detection system 120 may utilize various machine learning techniques to perform such analysis.

Fracking detection system 122 may be configured to detect the presence of a fracking crew on a detected well pad. For example, fracking detection system 122 may be configured to analyze the aerial images and identify changes in the landscape that may be indicative of fracking activities. Like pad detection system 120, fracking detection system 122 may utilize various machine learning techniques to perform such analysis.

In some embodiments, fracking detection system 122 may be called or initialized when a new spud date is reported. In some embodiments, a spud date may refer to the date the main drill bit begins drilling into the ground. In some embodiments, well activity analytics system 116 may call or initiate fracking detection system 122 by receiving an indication of a new spud date from user device 102 or third party system 106. Once the spud date has been reported, image handler 118 may be configured to request historical aerial images preceding the spud date. For example, image handler 118 may request aerial images for two months preceding the spud date. These aerial images may be used as a baseline to confirm the presence of a drilling rig. For example, fracking detection system 122 may analyze the images using one or more machine learning techniques to identify or confirm the presence of or increase in the presence of metal in the geographic location. In some embodiments, a high radar return may indicate that metal is present in the geographic location given the environmental context. In some embodiments, a high radar return may refer to the amount of the emitted radar signal that returns to the satellite, i.e., backscatter. The presence of or increase in the presence of metal may indicate the presence of a rig and drilling crew on a well pad after the spud date.

Once the presence of metal has been confirmed, fracking detection system 122 may use the rig release date to trigger a new detection. For example, based on the rig release date, fracking detection system 122 may continue to monitor well pad to determine a drop in metal onsite. A drop in metal onsite may indicate that the rig has left the well pad.

Fracking detection system 122 may then continue to monitor aerial images of the well pad for the expected start of the fracking crew activity. In some embodiments, when a detection of metal is identified, fracking detection system 122 may communicate with user device 102 or third party system 106 to perform a quality check to ensure that a reported fracking date is not present on the pad. Such check minimizes or reduces the chance of double counting well activity. If, for example, there is not a reported fracking data on the well pad in the last X days (e.g., last 90 days), then fracking detection system 122 may use the first metal detection date as the start of the fracking crew. Fracking detection system 122 may classify this date as an “active fracking crew.”

In some embodiments, for all uncompleted wells on the well pad, fracking detection system 122 may assume a range of completion efficiency based on the play or geographic region. For example, fracking detection system 122 may assume a five-to-eight day completion efficiency depending on the play or geographic region. Using a more specific example, if there is one uncompleted well on the well pad, fracking detection system 122 may assume a fracking crew will be on that well pad for eight days; if there are three uncompleted wells on the well pad, fracking detection system 122 may assume a crew will be active on that well pad for 24 days (e.g., three wells times eight day completion efficiency).

In some embodiments, the active status of a well pad may be continued until the completion efficiency duration assumption is reached. For example, if fracking detection system 122 first detects the presence of metal or elevated metal onsite after a confirmed rig release date of Aug. 1, 2023 and there are three uncompleted wells on the pad with a play completion efficiency of eight days, then well activity analytics system 116 may maintain the active status on that pad until Aug. 24, 2023. Well analytics system 116 may maintain the active status even if there is a drop in metal concentration post initial detection.

In some embodiments, after a completion becomes reported, well activity analytics system 116 may overwrite the detected start and end dates with the reported information.

In some embodiments, server system 104 may also include a training environment 124. Training environment 124 may be used to train the machine learning models used by pad detection system 120 and fracking detection system 122. In some embodiments, training may include use of a set of training images, which are labeled to indicate the presence or absence of a well pad or a fracking crew. During the training process, the machine learning models can may be optimized to detect these features in new, unlabeled images.

Furthermore, in some embodiments, server system 104 can be integrated with other systems or platforms, either in addition to or instead of the third-party system 106. This could include other data analysis platforms, GIS systems, or industry-specific software. The specific choice of data source could be optimized based on factors such as coverage, resolution, update frequency, and cost.

Although server system 104 may utilize data from the Sentinel satellites, alternative data sources could be used. Exemplary third party systems 106 could include other public or private satellite systems, aerial imagery, or even ground-based sensors. The specific choice of data source could be optimized based on factors such as coverage, resolution, update frequency, and cost.

In operation, well activity analytics system 116 may leverage data from the third party system 106. For example, well analytics system 116 may receive Sentinel satellites image captures of the Earth's surface, which may be processed by image handler 118. Image handler 118 may create a timeseries repository for identified pad locations. The timeseries repository may be a chronological series of satellite images for each pad location. This timeseries repository may allow well activity analytics system 116 to monitor changes in these pad locations over time.

In some embodiments, well activity analytics system 116 may monitor these pad locations for increases in metal onsite, which can be detected by aerial imagery provided by the third party system 106. The increases in metal onsite can be indicative of the start or end of fracking activities. By validating these increases with historic rig activity, fracking detection system 122 can determine the presence of a fracking crew onsite. This process allows the well activity analytics system 116 to detect completion activity, both a fracking start and a fracking end date, at the pad level.

While server system 104 may utilize data from the Sentinel satellites, it is to be understood that alternative data sources could be used. For instance, other public or private satellite systems could be used to provide satellite imagery. Aerial imagery could also be used, which could be obtained from aircraft or drones. Even ground-based sensors could be used, which could provide data on changes in the landscape at a more localized level. The specific choice of data source could be optimized based on various factors, such as the coverage of the data source, the resolution of the data it provides, the frequency at which it updates, and the cost of using it.

Regardless of the specific data source used, the well activity analytics system 116 is configured to process the data and integrate it into the timeseries repository. This allows the server system 104 to maintain a comprehensive and up-to-date view of fracking activities, regardless of the specific data source used.

In some embodiments, pad detection system 120 and fracking detection system 122 may leverage different machine learning techniques or different sets of input data to improve the accuracy of their detections. For example, pad detection system 120 could use a convolutional neural network to identify areas in the satellite images that have the characteristics of a well pad. Fracking detection system 122, on the other hand, could use a transformer-based neural network to identify changes in the landscape that are indicative of fracking activities. These machine learning techniques could be trained and optimized using a set of training images, which are labeled to indicate the presence or absence of a well pad or a fracking crew.

Furthermore, pad detection system 120 and fracking detection system 122 could use different sets of input data to improve their detections. For example, pad detection system 120 could use data on changes in vegetation or soil disturbance, in addition to the satellite imagery, to detect the presence of a well pad. Fracking detection system 122, on the other hand, could use data on changes in metal onsite, in addition to the satellite imagery, to detect the presence of a fracking crew. These additional data sources could provide additional context and information that can help improve the accuracy of the detections.

In some cases, web client application server 114 may present data to users through a user interface that is designed with specific widgets and visualizations. These widgets and visualizations can provide a graphical representation of the data, making it easier for users to understand and interpret the data. For instance, the user interface may include a map viewer that displays the locations of detected well pads and fracking activities. The map viewer can be customized with different styles and colors to highlight different aspects of the data. The user interface may also include a widget that displays the active completion activity by operator, providing a quick overview of the current fracking activities.

In addition to the map viewer and the active completion activity widget, the user interface may include other widgets and visualizations. For example, the user interface may include a bar chart that displays the completion activity over time, colored by detected and reported activities. This can provide a visual representation of the trends in fracking activities over time. The user interface may also include a tab that allows users to view satellite images of individual well pads through time. This can provide a detailed view of the changes in a well pad over time, which can be useful for detecting and monitoring fracking activities.

In some embodiments, the user interface design of web client application server 114 may vary. For instance, different user interface designs could be used to present the data in different ways, to interact with the data in different ways, or to customize the interface to suit individual user preferences. The specific choice of user interface design could be based on various factors, such as the types of data to be presented, the specific requirements of the users, and the capabilities of user device 102.

For example, the user interface could be designed to present the data in a more detailed or a more summarized form, depending on the specific requirements of the users. It could also be designed to allow users to interact with the data in different ways, such as by filtering the data, sorting the data, or drilling down into the data. The user interface could also be designed to be customizable, allowing users to choose which widgets and visualizations to display, how to display them, and in what order to display them.

Regardless of the specific user interface design used, web client application server 114 may be configured to present the data in a way that is easy to understand and interpret, leveraging widgets and visualizations to provide a graphical representation of the data. This allows users to quickly and easily gain insights into the fracking activities, enhancing their ability to make informed decisions.

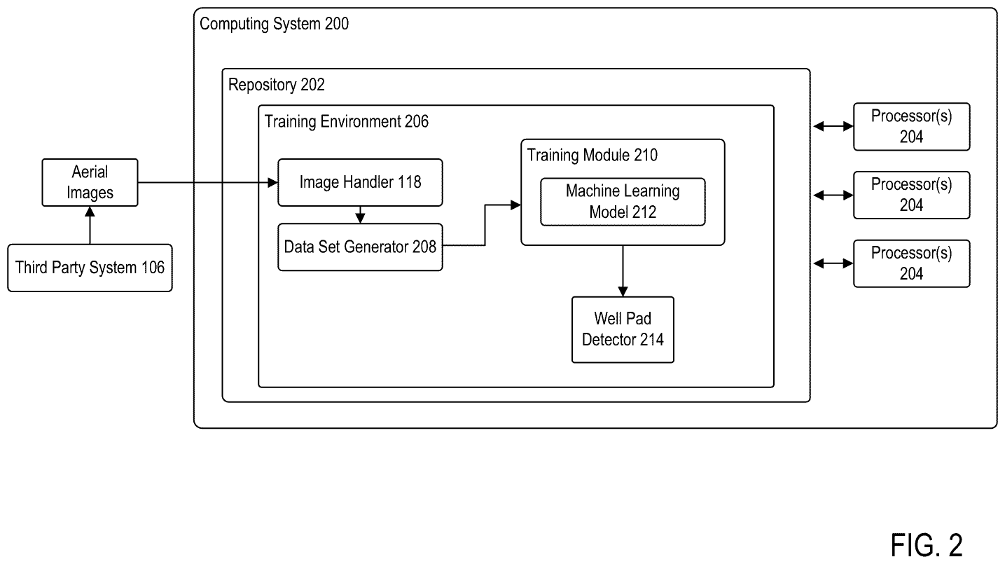

FIG. 2 is a block diagram illustrating a computing system 200, according to example embodiments. As shown, FIG. 2 may represent a training environment in which a machine learning model may be trained to identify well pads in aerial images. Computing system 200 may include a repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least training environment 206.

Training environment 206 may include image handler 118, data set generator 208, and training module 210. Each of data set generator 208 and training module 210 may include one or more software modules. The one or more software modules can be collections of code or instructions stored on a media (e.g., memory of computing system 200) that represent a series of machine instructions (e.g., program code) that implements one or more algorithmic steps. Such machine instructions may be the actual computer code the processor of computing system 200 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Image handler 118 may be configured to receive image data from third party system 106. For example, image handler 118 may receive a plurality of aerial images of a plurality of geographic areas from third party system 106. In some embodiments, image handler 118 may receive images captured by Sentinel satellites. In some embodiments, each aerial image may be associated with locational coordinates. For example, each aerial image may include coordinates that indicate a geographical location captured in the aerial image.

Data set generator 208 may be configured to generate a training data set for training machine learning model 212 to identify well pads in aerial images. In some embodiments, data set generator 208 may generate a training data set based on labeled images of the aerial images obtained from third party system 106. In some embodiments, the labels for the aerial images may be generated via an operator. For example, each of the plurality of aerial images may be displayed to one or more operators, who may annotate the plurality of aerial images to denote whether each aerial image contains a well pad. In some embodiments, the labeling may also include an indication of where the well pad is located on the image. In other words, each aerial image may be labeled with a bounding box around a given well pad and/or an indication of whether the aerial image contains a well pad.

Training module 210 may be configured to train machine learning model 212 based on the training data set. For example, training module 210 may train machine learning model 212 to indicate the presence or absence of a well pad in an aerial image. In some embodiments, training module 210 may train machine learning model 212 to output a binary number, where the binary number indicates whether the aerial image includes a well pad (e.g., 1) or does not include a well pad (e.g., 0). In some embodiments, training module 210 may train machine learning model 212 to generate or output a confidence in its prediction. For example, when generating an output of 0 or 1, machine learning model 212 may be trained to indicate its confidence in that output (e.g., 0.87)

In some embodiments, machine learning model 212 may be representative of a convolutional neural network. In some embodiments, machine learning model 212 may be pre-trained prior to the training process initiated by training module 210. For example, machine learning model 212 may be pretrained on image data from the ImageNet database. During training by training module 210, machine learning model 212 may undergo a transfer learning process, by which the information learned from training on ImageNet database may be transferred or applied to the task of learning whether an aerial image contains a well pad. Such transfer learning may result in an overall improvement in accuracy in detecting well pads.

Once trained, well pad detector 214 may be deployed in server system 104 for detecting the presence of well pads in aerial images.

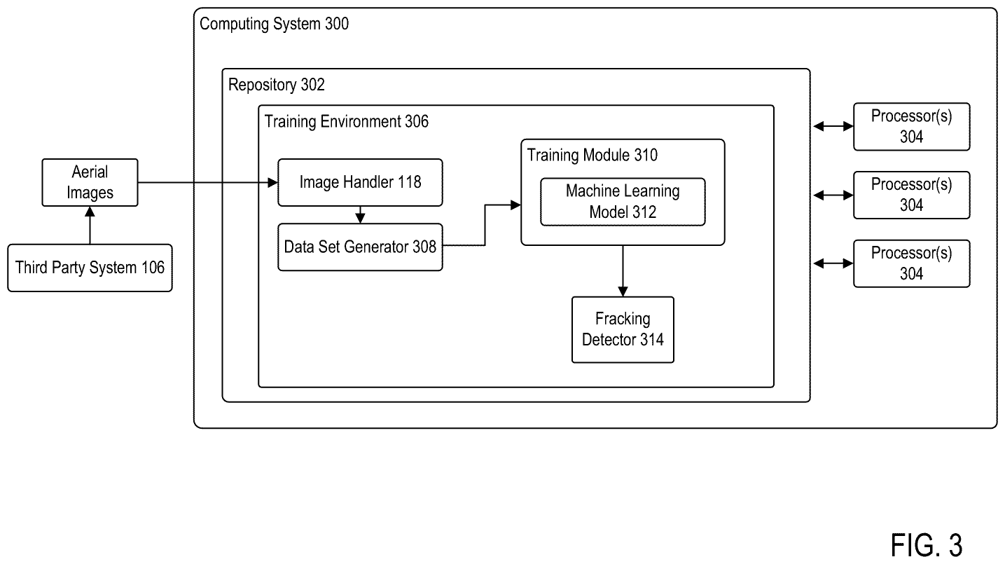

FIG. 3 is a block diagram illustrating a computing system 300, according to example embodiments. As shown, FIG. 3 may represent a training environment in which a machine learning model may be trained to identify fracking activities on a well pad based on aerial images. Computing system 300 may include a repository 302 and one or more computer processors 304.

Repository 302 may be representative of any type of storage unit and/or device (e.g., a file system, database, collection of tables, or any other storage mechanism) for storing data. Further, repository 302 may include multiple different storage units and/or devices. The multiple different storage units and/or devices may or may not be of the same type or located at the same physical site. As shown, repository 302 includes at least training environment 306.

Training environment 306 may include image handler 118, data set generator 308, and training module 310. Each of data set generator 308 and training module 310 may include one or more software modules. The one or more software modules can be collections of code or instructions stored on a media (e.g., memory of computing system 300) that represent a series of machine instructions (e.g., program code) that implements one or more algorithmic steps. Such machine instructions may be the actual computer code the processor of computing system 300 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Image handler 118 may be configured to receive image data from third party system 106. For example, image handler 118 may receive a plurality of aerial images of a plurality of geographic areas from third party system 106. In some embodiments, image handler 118 may receive images captured by Sentinel satellites. In some embodiments, each aerial image may be associated with locational coordinates. For example, each aerial image may include coordinates that indicate a geographical location captured in the aerial image. In some embodiments, the plurality of aerial images are radar images.

Data set generator 308 may be configured to generate a training data set for training machine learning model 312 to determine whether an image exhibits fracking activity on a well pad. In some embodiments, data set generator 308 may generate a training data set based on labeled images of the aerial images obtained from third party system 106. In some embodiments, the labels for the aerial images may be generated via an operator. For example, each of the plurality of aerial images may be displayed to one or more operators, who may annotate the plurality of aerial images to denote whether each aerial image illustrates fracking activity. In some embodiments, an aerial image illustrating fracking activity may be an aerial image for which metal is detected in the image. In other words, data set generator 308 may label an image as illustrating fracking activity based on whether the image includes illustrates metal on or near the well pad.

Training module 310 may be configured to train machine learning model 312 based on the training data set. For example, training module 310 may train machine learning model 312 to indicate the presence or absence of metal on a well pad in an aerial image. In some embodiments, training module 310 may train machine learning model 312 to output a binary number, where the binary number indicates whether the aerial image includes the presence of metal on or near a well pad (e.g., 1) or does not include the presence of metal on or near a well pad (e.g., 0). In some embodiments, training module 310 may train machine learning model 312 to generate or output a confidence in its prediction. For example, when generating an output of 0 or 1, machine learning model 312 may be trained to indicate its confidence in that output (e.g., 0.48).

In some embodiments, training module 310 may train machine learning model 312 to generate its output based on a threshold amount of metal being present in the image. For example, training module 310 may set the threshold of metal at 25%. In other words, training module 310 may train machine learning model 312 to indicate the presence of metal on or near a well pad if the well pad includes the threshold amount of metal onsite.

In some embodiments, training module 310 may train machine learning model 312 to detect various stages of fracking based on an amount of metal present in the aerial images. For example, assume that there are three threshold values: x %, y %, and z %, where x %<y %<z %. Training module 310 may train machine learning model 312 to indicate that no fracking activity is present if the amount of metal in the aerial image is less than x %. Training module 310 may train machine learning model 312 to indicate that a spud date based on the metal in the aerial image being between x % and y %. Training module 310 may train machine learning model 312 to indicate that fracking has begun based on the metal in the aerial image being between y % and z %.

In some embodiments, machine learning model 312 may be representative of a convolutional neural network. In some embodiments, machine learning model 312 may be representative of a transformer-based neural network. In those embodiments, in which machine learning model 312 is a convolutional neural network or transformer-based neural network, the training process would involve raw radar images and their corresponding labels. In some embodiments, machine learning model 312 may be representative of a light gradient-boosting machine (LightGBM). In those embodiments in which machine learning model 312 is a LightGBM, the raw radar images may be pre-processed into tabular data (such as thresholds of pixel counts, e.g., VV band has 183 pixels that are above the value 100 on a 0-255 scale) prior to training.

Once trained, fracking detector 314 may be deployed in server system 104 for detecting the presence of metal on or near a well pad.

In some embodiments, the presence of metal may indicate a detection of fracking activity on the well pad. In some embodiments, fracking detector 314 may calculate an exponentially weighted moving average (EWM) of the last x-image confidences (e.g., last three image confidences). If, for example, fracking detector 314 determines that the EWM is above a threshold, then fracking detector 314 may mark the start of fracking crew activity. In some embodiments, the threshold may be selected during model training through a modified receiver operating characteristic (ROC) curve. In some embodiments, fracking detector 314 or an operator may consult a SME-created reference database for how many days the fracking crew should remain on site given the number of wells to frack. Fracking detector 314 or operator may mark that as the future end date for the frack crew to be on site (typically 10-30 days).

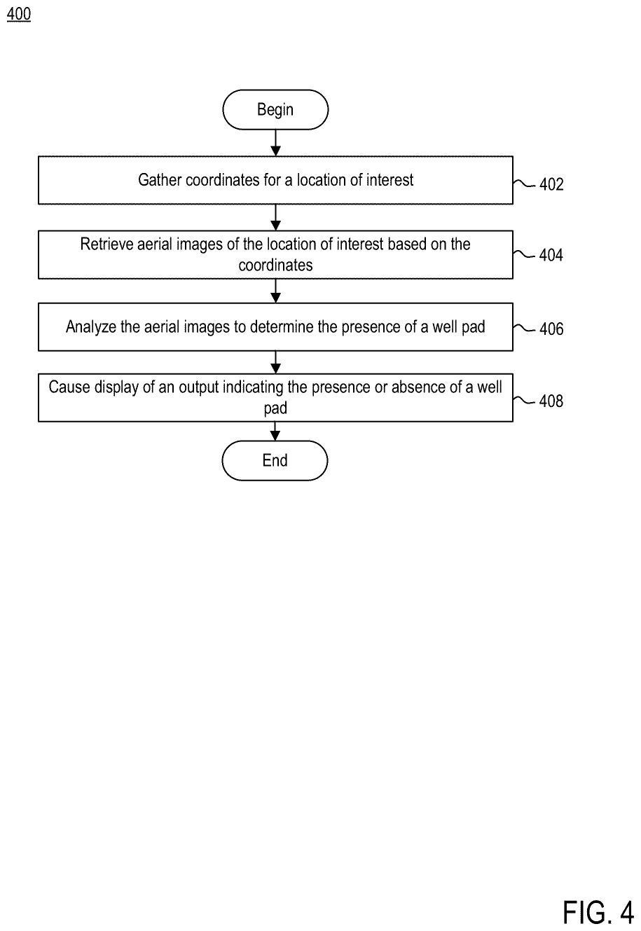

FIG. 4 is a flow diagram illustrating a method 400 for detecting the presence of a well pad, according to example embodiments. Method 400 may begin at step 402.

At step 402, server system 104 may gather coordinates for a location of interest. In some embodiments, server system 104 may gather or receive coordinates for a location of interest from user device 102 via application 110.

At step 404, server system 104 may retrieve aerial images of the location of interest based on the coordinates. For example, well activity analytics system 116 may request aerial images of the location of interest from third party system 106 by providing third party system 106 with the coordinates of the location of interest. In some embodiments, the aerial images may be satellite images of the area of interest.

At step 406, server system 104 may analyze the aerial images to determine the presence of a well pad. For example, well activity analytics system 116 may provide the aerial images to pad detection system 120. Pad detection system 120, utilizing pad detector 214, may analyze the aerial images by providing the aerial images, as input, to pad detector 214. Pad detector 214 may analyze the aerial images to determine the presence of a well pad. Based on the analysis, pad detector 214 may provide an indication of whether a well pad is in the aerial image. For example, pad detector 214 may generate a binary output that indicates the presence or absence of a well pad from the aerial image.

At step 408, server system 104 may cause display of the output. For example, server system 104 may provide the output to user device 102 through one or more graphical user interfaces displayed via application 110.

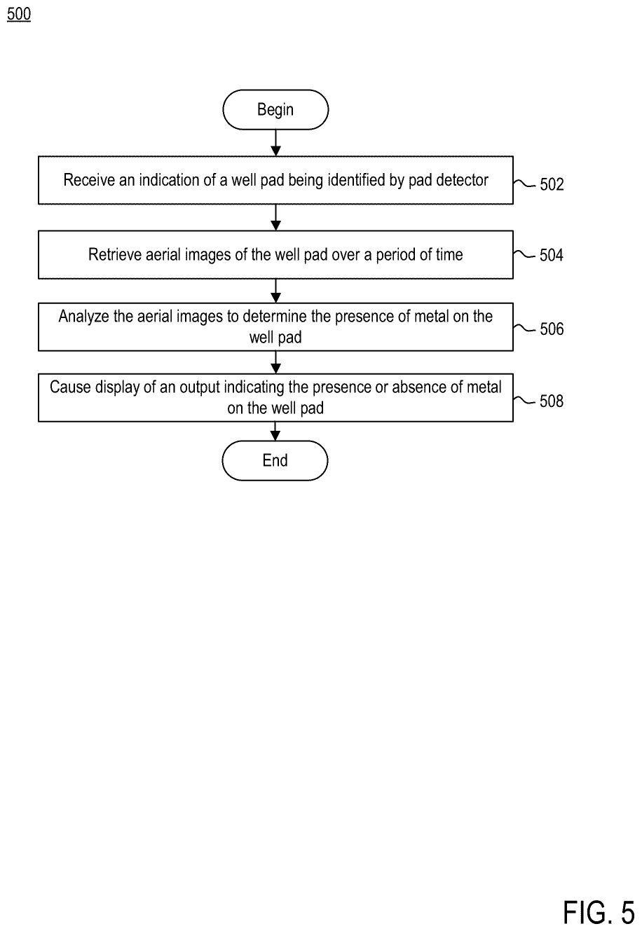

FIG. 5 is a flow diagram illustrating a method 500 of detecting fracking activity on a well pad, according to example embodiments. Method 500 may begin at step 502.

At step 502, server system 104 may identify a well pad to monitor. In some embodiments, server system 104 may identify a well pad to monitor by receiving an indication of a well pad being identified. In some embodiments, server system 104 may identify a well pad to monitor based on reported rig data. For example, if a rig has been active on a well pad, pad detection system may identify this well pad for monitoring.

In some embodiments, server system 104 may identify a well pad based on aerial images of a geographic region of interest. In some embodiments, if, for example, a single image meets a high confidence threshold that a well pad exists in the geographic region, then server system 104 may assign the pad construct date to that image's day. In some embodiments, if, for example, x-consecutive images (e.g., three consecutive images) meet a lower confidence threshold, then server system 104 may assign the pad construct date to the earliest date of those x-consecutive images. In this manner, if server system's 104 confidence is lower than a threshold, server system 104 may require detection of the well pad in multiple images before assigning a pad construct date in order to generate an overall higher confidence prediction.

At step 504, server system 104 may retrieve aerial images of the well pad over a period of time. For example, well activity analytics system 116 may request aerial images of the location of interest from third party system 106 by providing third party system 106 with the coordinates of the location of interest. In some embodiments, the aerial images may be satellite images of the area of interest. In some embodiments, the aerial images may be images starting three months prior to the rig activity.

At step 506, server system 104 may analyze the aerial images to determine the presence of metal on the well pad or an increase in the presence of metal on the well pad. For example, well activity analytics system 116 may provide the aerial images to fracking detection system 122. Fracking detection system 122, utilizing fracking detector 314, may analyze the aerial images by providing the aerial images, as input, to fracking detector 314. Fracking detector 314 may analyze the aerial images to determine the presence of metal on the well pad. Based on the analysis, fracking detector 314 may provide an indication of whether metal or an increase in metal has been identified.

At step 508, server system 104 may cause display of the output. For example, server system 104 may provide the output to user device 102 through one or more graphical user interfaces displayed via application 110.

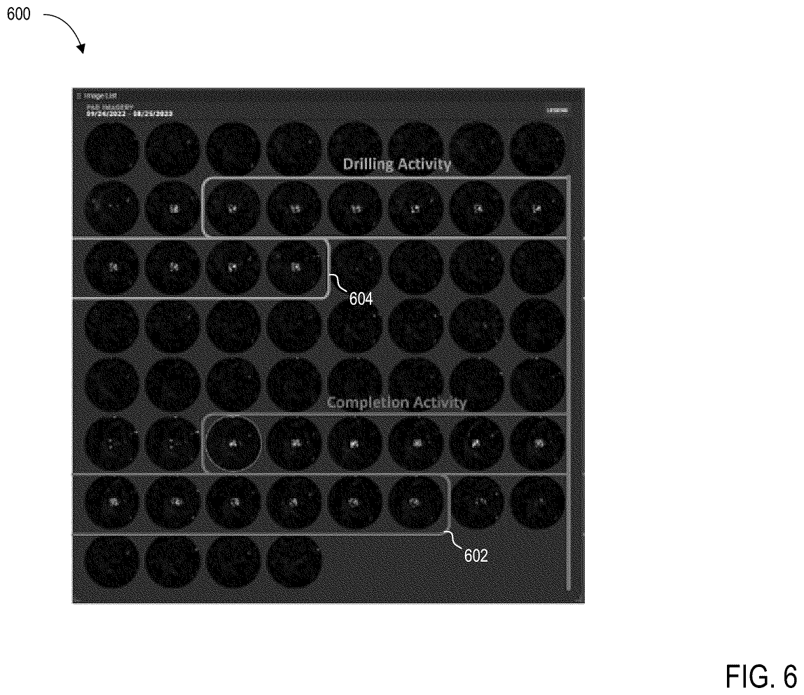

FIG. 6 illustrates a plurality of radar images 600, according to example embodiment. In some embodiments, plurality of radar images 600 may represent a timeseries repository of images of a geographic location in which pad detector 214 identified a well pad. Fracking detector 314 may be configured to analyze plurality of radar images 600 to identify various phases of a fracking process. Drilling activity 602 may correspond to a reported drilling event. Completion activity 604 may correspond to a predicted activity, as generated by fracking detector 314, based on an elevated presence of metal post drilling.

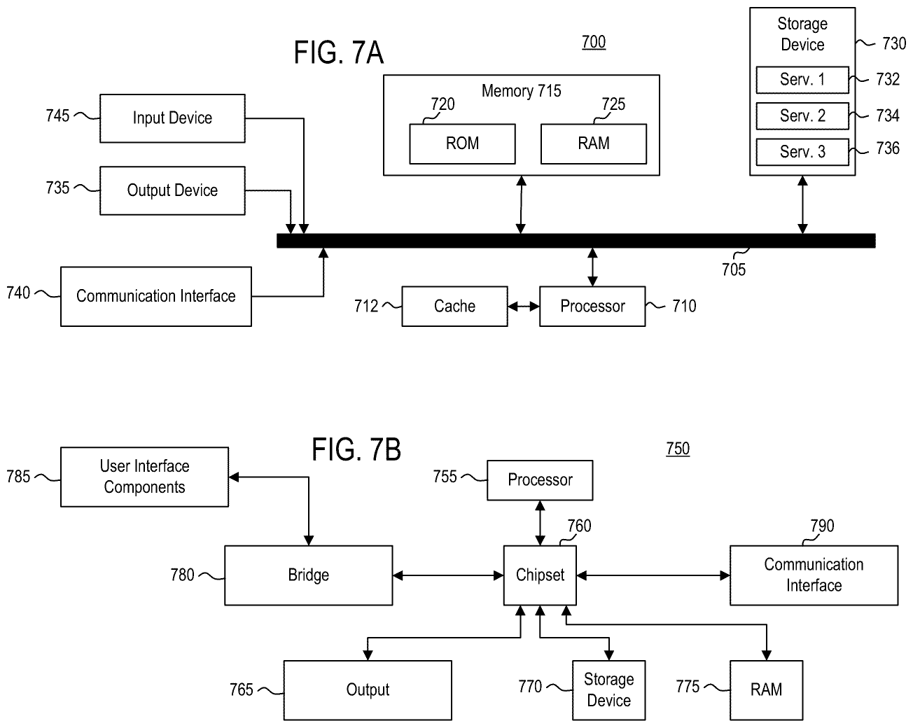

FIG. 7A illustrates a system bus architecture of computing system 700, according to example embodiments. System 700 may be representative of at least user device 102, server system 104, or computing system 200. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710.

System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735 (e.g., display), and so forth, to carry out the function.

FIG. 7B illustrates a computer system 750 having a chipset architecture that may represent user device 72. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755.

In this example, chipset 760 outputs information to output 765, such as a display, and may read and write information to storage device 770, which may include magnetic media, and solid-state media, for example. Chipset 760 may also read data from and write data to storage device 775 (e.g., RAM). A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or storage device 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for monitoring fracturing activities, comprising:
receiving, by a computing system, aerial images of a geographical region;
analyzing, by the computing system, the aerial images to detect a presence of a well pad within the geographical region;
receiving, by the computing system, further aerial images of the well pad;
monitoring, by the computing system, the further aerial images to identify fracking activity on the well pad; and
recording, by the computing system, the fracking activity.

2. The method of claim 1, further comprising:
creating, by the computing system, a chronological series of aerial images for each detected well pad location to form a time-series repository.

3. The method of claim 1, wherein monitoring, by the computing system, the further aerial images to identify the fracking activity on the well pad comprises:
detecting a presence of metal in the further aerial images.

4. The method of claim 3, wherein detecting the presence of metal in the further aerial images comprises:
detecting metal in at least three aerial images.

5. The method of claim 1, wherein monitoring, by the computing system, the further aerial images to identify fracking activity on the well pad comprises:
detecting an increase or decrease in a presence of metal in the further aerial images.

6. The method of claim 1, wherein analyzing, by the computing system, the aerial images comprises:
employing, by the computing system, a machine learning model that has been trained using a set of training images labeled to indicate the presence or absence of a well pad.

7. The method of claim 1, further comprising:
triggering, by the computing system, a notification to a user interface when a change in metal onsite is detected that indicates a start or end of fracking activities.

8. A non-transitory computer readable medium comprising one or more sequences of instructions, which, when executed by a processor, causes a computing system to perform operations comprising:
receiving, by a computing system, aerial images of a geographical region;
analyzing, by the computing system, the aerial images to detect a presence of a well pad within the geographical region;
receiving, by the computing system, further aerial images of the well pad;
monitoring, by the computing system, the further aerial images to identify fracking activity on the well pad; and
recording, by the computing system, the fracking activity.

9. The non-transitory computer readable medium of claim 8, further comprising:
creating, by the computing system, a chronological series of aerial images for each detected well pad location to form a time-series repository.

10. The non-transitory computer readable medium of claim 8, wherein monitoring, by the computing system, the further aerial images to identify fracking activity on the well pad comprises:
detecting a presence of metal in the further aerial images.

11. The non-transitory computer readable medium of claim 10, wherein detecting the presence of metal in the further aerial images comprises:
detecting metal in at least three aerial images.

12. The non-transitory computer readable medium of claim 8, wherein monitoring, by the computing system, the further aerial images to identify fracking activity on the well pad comprises:
detecting an increase or decrease in a presence of metal in the further aerial images.

13. The non-transitory computer readable medium of claim 8, wherein analyzing, by the computing system, the aerial images comprises:
employing, by the computing system, a machine learning model that has been trained using a set of training images labeled to indicate the presence or absence of a well pad.

14. The non-transitory computer readable medium of claim 8, further comprising:
triggering, by the computing system, a notification to a user interface when a change in metal onsite is detected that indicates a start or end of fracking activities.

15. A system comprising:
a processor; and
a memory having programming instructions stored thereon, which, when executed by the processor, causes the system to perform operations comprising:
receiving aerial images of a geographical region;
analyzing the aerial images to detect a presence of a well pad within the geographical region;
receiving further aerial images of the well pad;
monitoring the further aerial images to identify fracking activity on the well pad; and
recording the fracking activity.

16. The system of claim 15, wherein the operations further comprise:
creating a chronological series of aerial images for each detected well pad location to form a time-series repository.

17. The system of claim 15, wherein monitoring the further aerial images to identify fracking activity on the well pad comprises:
detecting a presence of metal in the further aerial images.

18. The system of claim 17, wherein detecting the presence of metal in the further aerial images comprises:
detecting metal in at least three aerial images.

19. The system of claim 15, wherein monitoring the further aerial images to identify fracking activity on the well pad comprises:
detecting an increase or decrease in a presence of metal in the further aerial images.

20. The system of claim 15, wherein analyzing the aerial images comprises:
employing a machine learning model that has been trained using a set of training images labeled to indicate the presence or absence of a well pad.
